(19) United States
(12) Patent Application Publication
(10) Pub. No.: US 2003/0078162 A1
(43) Pub. Date: Apr. 24, 2003

(54) Absorbent sulfur oxide composition and associated use

(76) Inventors: Gerard Martin, Rueil Malmaison (FR); Luc Nougier, Le Vesinet (FR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/295,857

(22) Filed: Nov. 18, 2002

Related U.S. Application Data
(63) Continuation of application No. 08/993,141, filed on Dec. 18, 1997, now abandoned.
Application No. 08/993,141 is a continuation of application No. 08/613,602, filed on Mar. 11, 1996, now abandoned.
Application No. 08/613,602 is a continuation of application No. 08/199,197, filed on Feb. 28, 1994, now abandoned.

(30) Foreign Application Priority Data
Jun. 29, 1992 (FR) 92/08076

(51) Int. Cl. B01J 23/02

(52) U.S. Cl. 502/407; 502/400; 502/340

(57) ABSTRACT

Absorbent sulfur oxide composition, regeneratable, usable in thermal generators and comprising a magnesian type pulverulent absorbent. According to the invention, the composition further comprises a powder having a grain size less than 50 micrometers and containing at least one metallic oxide.

### CROSS-REFERENCE TO RELATED APPLICATIONS

This application is a Continuation application of application Ser. No. 08/993,141, filed Dec. 18, 1997, which is a Continuation of application Ser. No. 08/613,602, filed Mar. 11, 1996, which is a Continuation of application Ser. No. 08/199,197, filed Feb. 28, 1994.

### FIELD OF THE INVENTION

The present invention relates to sulfur oxide absorbent mixtures, regeneratable and usable preferably in multifuel thermal generators utilizing notably fuels with a high sulfur content.

The absorbent mixtures according to the present invention may be implemented in thermal generators which produce for example steam or warm fluids. They may also be used in process heat recovery boilers such as those provided for example downstream from FCC regenerators.

### BACKGROUND OF THE INVENTION

Heat generators may be operated only if the effluents they discharge to the atmosphere are purified from most of the pollutants initially contained in the effluents.

In fact, sulfur oxide emissions are limited in most industrialized countries by severe regulations.

Various ways of reducing sulfur oxide emissions by thermal generators have already been proposed.

A known technique consists in injecting absorbents, generally of calcic origin, directly into the combustion chamber. Another technology recommends the injection of an absorbent into a specific zone located downstream from the combustion chamber. It is also known to capture the sulfur at low temperature in another specific device located downstream from the heat exchange surfaces.

Treating the effluents downstream from exchange surfaces yields good results but is generally more costly than the other conventional treatments performed directly in the boiler. Besides, this technology implies a larger volume of the assembly, which is no longer compact.

Patent FR-A-2,363,720 also describes how to perform an in-situ desulfurization process in a specific chamber fitted in the heat generator. This technology leads to interesting results as far as the sulfur capture efficiency and the investment and operating costs are concerned.

The absorbent used in this type of boiler mainly consists of a calcic substance which is discharged after use. In the end, the used absorbent might lead to storage and/or dumping problems, on the one hand, because of the high discharged volumes and, on the other hand, because the used absorbent contains substances which are harmful to the environment, such as heavy metals resulting from the combustion.

In order to remedy the problem linked to the volumes to be stored, the French patent application FR-2,671,855 filed by the applicant proposes to use absorbents operating at a lower temperature and which are regeneratable, i.e. capable of recovering their original state after capturing sulfur oxides. The absorbents used therefore are mainly pulverulent magnesian absorbents such as dolomite, magnesium oxide or magnesium carbonate.

The necessary installation for implementing such absorbents includes a desulfurization chamber fitted in the boiler and located in a zone where temperatures are suited for the use of magnesian absorbents. Such an installation further comprises a specific means for regenerating the used absorbent and means for treating the absorbent and/or the regeneration gases.

The object of the present invention is to improve the absorbents used in this type of installation, notably through a decrease in the absorbent volumes used, through a higher desulfurization efficiency and through a decrease in the mechanical wear of the surfaces in contact with the absorbent composition.

The amount of absorbent consumed by a thermal generator implementing the present invention may be reduced by a factor ranging between 10 and 1000, most often between 50 and 200.

In the field of catalytic cracking of heavy petroleum charges containing sulfur, masses known as transfer masses are used for capturing in the regenerator(s) the sulfur released during the combustion of the coke deposited on the catalyst. Back in the cracking reactor and in the stripper, these transfer masses release, mainly in the form of hydrogen sulfide, the sulfur captured in the regenerator(s).

Independently of or complementing the transfer masses, the regeneration effluents resulting from the catalytic cracking may be treated in an appropriate device for extracting the sulfur oxides therefrom. Patent application FR-2,674,766 discloses a technology of this type which prevents harmful discharges of sulfur oxides to the atmosphere by using an absorbent mass in an entrained bed.

In the same field, patent U.S. Pat. No. 4,963,520 describes a transfer mass formulation, based on a MgA1₂O₄ spinel, to which a third metal is added for promoting the oxidation of SO₂ to SO₃ and a fourth metal is added, which promotes the mass reduction. To be able to be used in catalytic crackers, the geometric characteristics of the mass have to be identical to those of the cracking catalyst itself and exhibit very high mechanical strength properties to avoid wear. The average diameter of these masses is generally higher than 50 micrometers. On account of these constraints, they are sophisticated and therefore costly products.

### DESCRIPTION OF THE INVENTION

The object of the present invention is to improve the desulfurization performances by proposing a product of a low manufacturing cost.

The objectives stated above are reached by the present invention which relates to a sulfur oxide absorbent which is a regeneratable mixture comprising a pulverulent absorbent of the magnesian type.

According to the invention, a second powder of fine grain size containing at least one metallic oxide is added to the known pulverulent magnesian absorbent.

The second powder may consist of one metallic oxide only.

The powder added preferably consists of grains having a diameter less than 50 micrometers.

The metal of the metallic oxide may be selected from the group consisting of the following metals Fe, Cu, Pt, Pd, V, Cr, Ce, Rh, W.

The metallic oxide is preferably deposited on a support based on a material selected from the group formed by alumina, silica, zirconia.

Such a support gives the metallic oxide a higher sintering resistance and allows all its properties to be retained, even in case of prolonged use.

The mixture according to the invention may be implemented in heat generators or in heat recovery boilers used in catalytic cracking processes, such as those defined at the beginning of the description.

Tests have shown that the addition of a second powder such as that defined above plays an active part in the desulfurization stage by promoting the oxidation of SO2 to SO3, which is more reactive, on the one hand, and in the stage of reduction of the absorbent on the other hand, during which the sulfur is released and fed into an adapted treating chain by accelerating the regeneration process.

The second powder is admixed with the first one in order to obtain a mixture in which the second powder represents 5 to 70% and preferably 10 to 50% of the total mass. Besides its action on the oxidation of SO2 to SO3, the second powder also takes part in the capture of the sulfur oxides in the combustion effluents.

The formulation which is the object of the invention must be used in a desulfurization reactor at temperatures ranging between 400 and 900° C., preferably between 600 and 800° C. Below 600° C., the desulfurization rates and efficiencies are low and above 800° C., sintering phenomena start to destroy the active elements of the formulation, which requires a quicker absorbent change in the thermal generator.

According to an embodiment example of the invention, an entrained-bed reactor is supplied with fumes containing 2500 ppm of SO2. The residence time of the gases in the reactor is about 0.5 s and the temperature is maintained around 750° C. To desulfurize these fumes, the absorbent composition according to the invention is introduced in pulverulent form. The product is injected at the center of the gas stream to be treated, by means of an injector which provides a fast dispersion of the particles. The absorbent consists of a mixture of two powders MgO magnesia and a cerium-based active phase deposited on an alumina support. The average grain sizes of the magnesia and of the active phase support are respectively 3 and 20 microns. The active phase content of the absorbent is 11%.

The absorbent flow rate is adjusted in such a way that the Mg/S molar ratio (absorbent flow rate/flow rate of sulfur supplied by the fumes) is about nine. Under such conditions, the fumes desulfurization efficiency is of the order of 81%.

Furthermore, the mixture consisting of the magnesian absorbent and of the powder containing one or several metallic oxides may be subjected to one or several sulfation-regeneration cycles without any appreciable decrease in the desulfurization efficiency.

The use of a mixture according to the invention allows various treatments of the used absorbent, or an upgrading or a recycling of these absorbents to be envisaged at fair costs, which is not the case with calcic absorbents.

The use of mixtures according to the invention also involves other advantages.

The size of the grains being very small, resistances to the inner transfer of the sulfur oxides towards the active sites are nearly annihilated, which allows the desulfurization performances to be improved in comparison with the systems utilizing grains of a larger size. The small grain size is also a factor which reduces considerably the risks of mechanical wear of the surfaces crossed by the absorbent in relation to absorbents with a larger grain size.

The absence of stress on the mechanical strength of the grains simplifies the manufacturing processes and makes th.ese mixtures less expensive than the transfer masses commonly used in catalytic crackers.

The mass of active elements, i.e. magnesium and metallic oxide(s), in relation to the total mass of the absorbent, is greater according to the invention than in the prior art, so that the implementation of pulverulent mixtures according to the invention may be achieved by means of an entrained bed with recovery at the boiler outlet, at the level of the final dust collector. The present invention therefore requires no heavy implementation utilizing a circulating bed with the formation of a dense phase in the desulfurization reactor and prededusting by cyclones or ballistic separators, as in the case of absorbents with a larger grain size. As a result, the investment cost as well as the running cost are markedly lower.

A mixture having particularly advantageous geometric characteristics comprises for example a very fine magnesian absorbent (of grain size less than 10 micrometers for example) and one or several metallic oxides supported by grains whose size ranges between 20 and 50 micrometers. In this case, distinctly lower fouling levels are observed on the exchange surfaces of the boiler crossed by the absorbent current.

The object of the present application may be provided with other modifications and/or additions by the man skilled in the art without departing from the scope of the present invention.

1. A sulfur oxide absorbent mixture which is regeneratable and usable in entrained beds of multifuel thermal generators, said mixture consisting of a fine powder of magnesian absorbent having a grain size of less than 10 micrometers, and a powder having a grain size less than 50 micrometers and containing at least one metallic oxide, the metal of the at least one metal oxide being selected from the group consisting of Fe, Cu, Pt, Pd, V, Cr, Ce, Rh and W, and said powder having a grain size of less than 50 micrometers representing 10 to 50% of the total mass of the mixture.

2. A mixture according to claim 1, wherein the at least one metallic oxide is deposited on an inorganic support based on a material selected from the group consisting of alumina, silica and zirconia.

3. A mixture according to claim 1, wherein the powder containing the at least one metallic oxide has a grain size between 20 and 50 micrometers.

4. A mixture according to claim 1, wherein the magnesian absorbent is selected from the group consisting of dolomite, magnesium oxide and magnesium carbonate.

5. The mixture according to claim 1, wherein the magnesian absorbent is magnesia.

6. A sulfur oxide absorbent mixture according to claim 1, wherein the at least one metal oxide being selected from the group consisting of Fe, Cu, Pt, Pd, V, Cr, Rh and W.
